(19) United States
(12) Patent Application Publication
(10) Pub. No.: US 2003/0140487 A1
(43) Pub. Date: Jul. 31, 2003

(54) Method for producing a carrier strip comprising a large number of electrical units, each having a chip and contact elements

(76) Inventor: Andreas Plettner, Starnberg (DE)

Correspondence Address: Timothy M Kelley, Michael Best & Friedrich, 100 East Wisconsin Avenue, Milwaukee, WI, 53202-4108, US

(21) Appl. No.: 10/312,527

(22) PCT Filed: Mar. 7, 2001
(86) PCT No.: PCT/EP01/02572

(30) Foreign Application Priority Data
Mar. 24, 2000 (DE) 100 14 620.1

(51) Int. Cl. H01R 43/00

(52) U.S. Cl. 29/827; 29/840; 29/852

(57) ABSTRACT

Method for manufacturing a carrier tape with a plurality of electrical units, whereby the carrier tape is intended for the manufacture of transponders and the method comprises the following steps: provision of a plurality of prefabricated chips with at least one connection surface; provision of a carrier tape for accommodating the chips; feeding of the carrier tape to a chip placement device, placing of at least one chip on the carrier tape, provision of a metallized plastic foil or metallic foil for forming at least one contact element; feeding of the metallized plastic foil or metallic foil to the carrier tape, joining of the metallized plastic foil or metallic foil to at least one connection surface of at least one chip for producing an electrical unit from the chip and contact element.

This invention relates to a method for the manufacture of a carrier tape with a plurality of electrical units, each comprising a chip and contact elements according to the preamble of patent claim 1, as well as to a carrier tape for the accommodation of the electrical units according to the preamble of patent claims 16 and 17.

Contactless chip cards are increasingly replacing contact-bearing chip cards. The reason for this may be in particular that contactless chip cards are easier to handle, of more rugged design and consequently exhibit a lower susceptibility to faults and also offer a range of interesting, new possibilities in application, because they do not need to be inserted into a reading device.

As is well known, contactless chip cards comprise a conducting loop or antenna which is fitted to the chip card and with which the chip, also fitted to the chip card, can communicate with the outside world. To achieve this, the conductor loop must be connected to the chip contacts or the contacts of an appropriate module during the manufacture of the contactless chip card. To obtain this electrical connection between the conductor loop and the chip, various methods have already been suggested, whereby in particular the use of a chip module and contacting of a “bare” chip, i.e. of the chip itself and not in module form, using a “flip-chip” process or through wire bonds have become established.

FIG. 5 elucidates the principle of how according to the prior art normally an electrical connection is made between a chip module 1 and a conductor loop 4.

A chip module 1, containing a chip which is not shown, comprises contacts 2 accessible externally which are connected to the actual chip contacts, e.g. by a solder, adhesive or wire bonding process. With reference number 3 contact connections are indicated which provide an electrical connection via an electrical conductor 5 to the conductor loop 4 fitted to the chip card body 6. In order to finally obtain a contact between the conductor loop 4 at one end and the chip at the other end, the contacts 2 must be joined, electrically conducting, to the contact connections 3. For this, the module 1 is placed with the contact-bearing side onto the contact connections 3 by a tool.

FIG. 6 illustrates another method in which the bare chip 7 is placed onto the contact connections 3 by the flip-chip process. With this variant the chip 7 must be placed onto the connections 3 with its “active side”, i.e. the side bearing the connection surfaces 8. For this, it is necessary to “flip” the chip 7 which entails grasping the chip 7 twice from the carrier tape or from the wafer.

FIG. 7 illustrates how according to the prior art an electrical connection can be made between a chip 7 and a conductor loop 4 using wire bonds.

In order to achieve contacting in this case between the conductor loop 4 at one end and the chip 7 at the other, the chip 7 is fitted to the chip card body 6 and the contacts 8 joined, electrically conducting, to the contact connections 3 using wire bonds. Quite evidently, the chip 7 no longer needs to be flipped with this solution. However, the wire connections 9, established by the wire bonds, require a larger overall height for the chip card and must also be protected by a solid protective layer 10.

A different type of contacting is known from DE 196 09 636 C1. According to the possible solution given here, a chip module is fitted to a recess in the chip card body in such a way that the contacts present on the module surface are flush with the conductor tracks on the surface of the body, so that contacting of the conductor loop can be achieved with the module contacts. A disadvantage with this implementation is that the depth of the recess must be dimensioned extremely accurately in order to enable both contacts to meet in a planar manner.

Based on the known prior art, the object of the invention is to provide a possibility of making contacts between a chip and the antenna of a contactless chip card more simple and especially quicker, whereby these contacts are to exhibit a high electrical and mechanical reliability.

This object is resolved by the subjects of patent claims 1, 16 and 17.

Preferred embodiments of the invention form the subject of the subclaims.

The object of the invention is in particular solved through a process for the manufacture of a carrier tape with a plurality of electrical units, each having a chip and contact elements, whereby the contact elements are suitable of being connected, electrically conducting, directly with contact connections of external electrical components, whereby the connection of the contact elements to the chips occurs on the carrier tape and therefore before further processing of the chips and the contact elements consist of a metallized plastic foil or metallic foil to be applied to the chips.

According to a particular aspect of this invention, electrical units, each having a chip and contact elements, are produced on a carrier tape, whereby these units are used to provide an electrical connection between the bare chip and a conductor loop or antenna present in a chip card body. Here, the contact elements are preferentially connection lugs which are directly connected on the carrier tape to the connection surfaces of the chip. The contact elements which are preferentially embodied as connection lugs have dimensions which enable trouble-free contacting with the contact connections of the conductor loop or antenna, whereby the overall height of the chip card due to the flat protruding connection lug is at the most insignificantly increased. In particular, these contact elements can be implemented so long that they enable a connection of the chip with the contact connections situated on the opposite side of the connection surface of the chip, whereby, as described above, the rotation using the flip-chip process normal in the prior art is avoided. The actual contacting with the antenna can occur extremely easily and quickly. Furthermore, the connection lugs exhibit a high mechanical tensile loading capability and therefore high reliability, so that adhering the chip to the chip card body is under certain circumstances no longer required, whereby the process times are substantially shortened due to the omission of the dwell time during adhesion and a reduction of the tensile loading on the chip itself arises.

The actual form of the contact elements arises through cutting them out from the applied contact foil, whereby the cutting out preferentially occurs with a laser. Alternatively to this, the fitted foil can be pre-structured so that extensive cutting steps can be saved. In particular, the foil can be embodied in the form of a tape with the desired width of the connection lugs. Furthermore, the connection lugs or wires can also be fitted to the connection surfaces of the chip using wire bonders.

Apart from the advantages described above, the stated method in particular exhibits the advantage that an efficient production of electrical units occurs already on the carrier tape and therefore the tedious individual contacting of each individual chip is no longer required. Moreover, a number of chips can be contacted on the carrier tape quasi simultaneously and even a quasi simultaneous contacting of the connection surfaces of a number of chips can be achieved with a foil placed over the chips on the carrier tape.

The electrical unit finally produced is extremely rugged, because the contact elements withstand high tensile loadings due to their dimensioning and due to the contact surfaces which are preferentially embodied in a suitable size so that the later encapsulation of the chip plays a less significant role. In particular, so-called “endless tapes” can be produced. An advantageous variant arises if the electrical units are fitted to the carrier tape such that the contact elements are spaced orthogonal to both sides of the carrier tape. This leads to extremely easy handling when fitting the chips into the card bodies.

Furthermore, the contact elements can be connected to the connection surfaces of the chips such that they run parallel to the surface of the carrier tape. This means, for example, that when fitting the connection lugs or wire using a wire bonder it must not be guided orthogonal to the carrier tape direction, because the bond direction and carrier tape direction are identical. This means that the process times when fitting the connection lugs or wires are substantially shortened, because stopping the carrier tape to fit the connection lugs or wires is no longer required.

An important advantage of the “endless tape” with electrical units is based on the fact that the endless tape can be rolled up with the electrical units, whereby the storage and transport of the electrical units is simplified. Furthermore, no ESD (electrostatic discharge) occurs during the manufacture of the chip cards themselves. In order to avoid such discharges during the manufacture of the electrical units on the carrier tape, the carrier tape is preferentially earthed. In particular, the feed of the endless tape to the chip placement system is easy to arrange via a toothed wheel.

### Preferred embodiments of this invention are explained in more detail in the following with reference to the enclosed drawings. Here, the drawings depict individually:

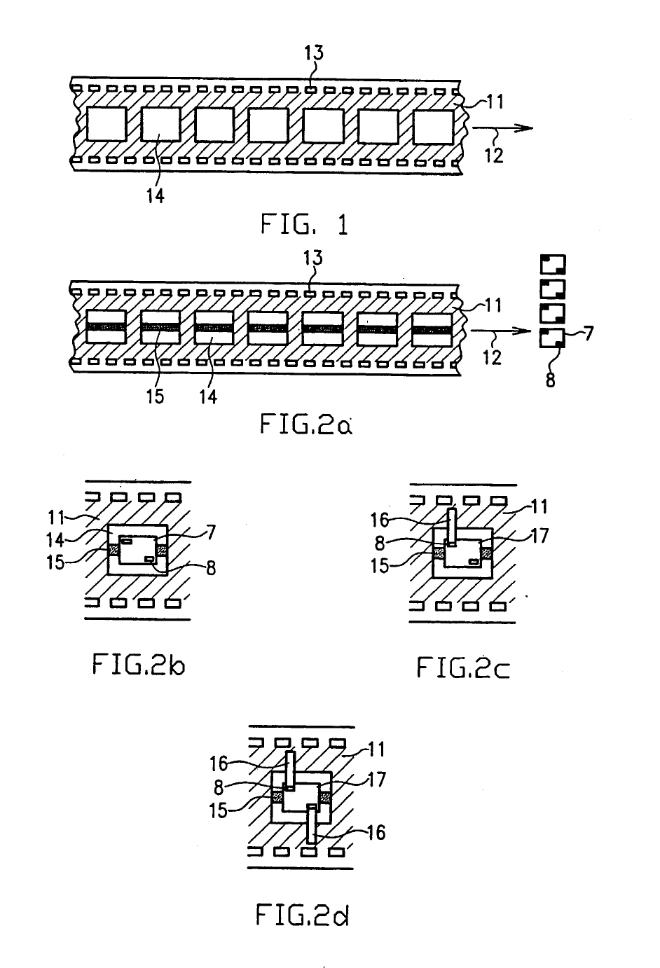

FIG. 1 a plan view on a carrier tape for the accommodation of electrical units;

FIG. 2 illustrates the individual method steps for producing an electrical unit on a carrier tape according to a preferred embodiment;

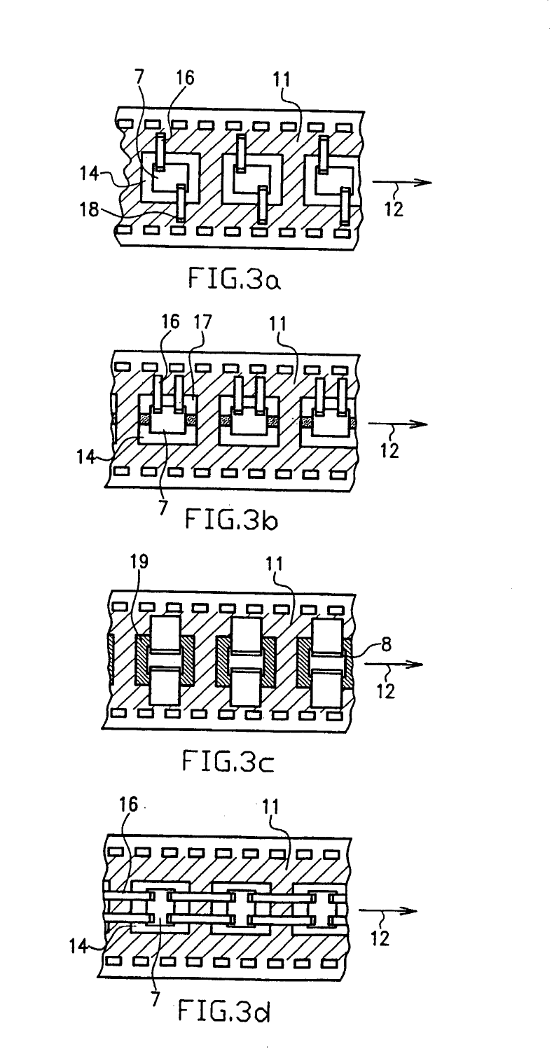

FIGS. 3a to 3d schematic plan views on a carrier tape which illustrate four examples of indicated possibilities for the formation of the carrier tape and four examples of possibilities for the formation of electrical units;

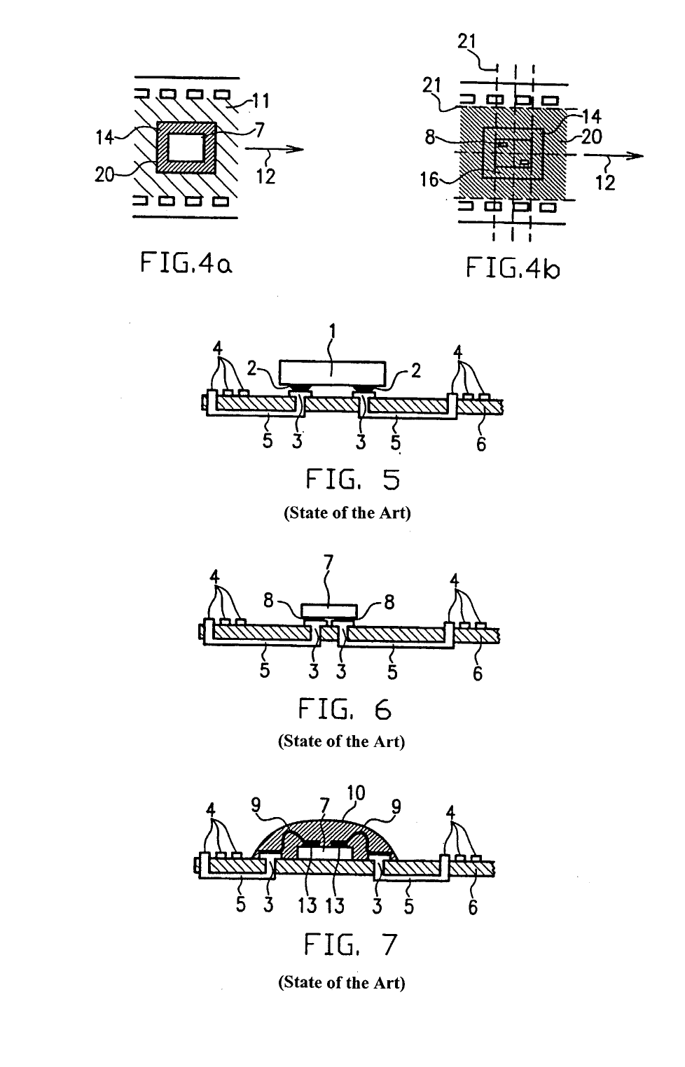

FIGS. 4 and 4a illustrate the individual process steps for producing an electrical unit on a carrier tape according to another preferred embodiment;

FIG. 5 a schematic representation of a module contact arrangement according to the prior art;

FIG. 6 a schematic representation of a chip contact arrangement according to the prior art using the flip-chip process; and

FIG. 7 a schematic representation of a chip contacting arrangement according to the prior art using the wire bonding process.

In FIG. 1 a plan view of a carrier tape 11 for the accommodation of electrical units is shown. The arrow 12 identifies the feed direction, according to which the carrier tape 11 is transported to a chip placement device (not shown). Preferentially, a so-called pick and place machine or a so-called die sorter machine is used as the chip placement device.

In parallel to the feed direction 12 the carrier tape 11 has perforations 13 along the edges in which a toothed wheel (not shown) can engage for the feed of the carrier tape 11 to the chip placement device. According to the illustrated preferred embodiment the carrier tape 11 has perforations 13 on both edges, whereby, for example, perforations 13 can also be applied to only one of the two edges. In particular, it is also possible to not fit any perforations 13, but, for example, deformations instead, which are implemented such that a special guidance device (not shown) can feed the carrier tape to the chip placement device. A number of equally large and equally protruding recesses 14, into each of which a chip can be placed, are provided centralized between the perforations 13. According to a particular embodiment of this invention, the recesses 14 are formed as penetrations. Preferentially, the carrier tape 11 is metallized on the top side.

FIG. 2 illustrates the individual process steps for the manufacture of a carrier tape 11 with a number of electrical units 17, each having a chip 7 with connection surfaces 8 and contact elements 16. According to the preferred embodiment of this invention illustrated in a), the carrier tape 11 has penetrations 14. Furthermore, the carrier tape 11 has a thin, preferentially double-sided adhesive tape 15 on its underside which is fitted about centrally along the carrier tape 11, therefore spanning over the penetrations 14. This enables fixing of the chips 7 within the penetrations 14 which is elucidated based on FIG. 2 b). A significant advantage of the use of a double-sided adhesive tape 15 for attaching the chips 7 is that the chips 7 can be stamped out during later fixing on a chip card body layer, preferentially from the carrier tape 11 along with the adhesive tape 15 and the adhesive tape 15 fixes the chip 7 automatically on the chip card body layer.

For the manufacture of the electrical units 17 on the carrier tape 11, it is passed, for example, using a toothed wheel, which is not shown and which engages the perforations 13, to a chip placement device which is also not illustrated. The chip placement device places in each case one chip 7 in a penetration 14 of the carrier tape 11. In a further step a metallized plastic foil or metallic foil is preferentially rolled off using a roll-off device (not illustrated). In a particularly preferred manner, an aluminum foil or a plastic foil with coated or vapor-deposited aluminum is used. In addition, the metallization on the plastic foil can be structured in order to largely correspond to the shape of the contact elements 16 and to largely avoid cutting steps later. In particular, the foil can exhibit the shape of a tape with the desired width, as shown in FIGS. 2 c) and d), whereby the contact elements 16 can be particularly implemented as connection lugs.

The contact elements 16 are now connected to the connection surfaces 13 of the individual chips 7, which can take place through soldering, bonding or adhering, preferentially during the rolling off of the foil over the carrier tape 11. Furthermore, the contact elements 16 can also be manufactured in the form of connection lugs or wires using a wire bonder.

According to a further embodiment of this invention, the metallized plastic foil or metallic foil can be placed over a number of chips 7 on the carrier tape 11, such that a quasi simultaneous contacting of the foil with the connection surfaces 8 of the chips 7 is facilitated. In this case the foil is parted using a parting device (not shown), e.g. using a laser, into the individual contact elements 16. Other embodiments provide for the connection of the foil to the connection surfaces 8 and the ensuing parting into the individual contact elements 16 using a single device. Electrical units are formed through the parting of the foil into the individual contact elements 16. The units arising in this way, each exhibiting a chip 7 with connected contact elements 16, such as for example connection lugs, exhibit, apart from a simple and particularly quick type of manufacture, the advantage that the chip must no longer be rotated, i.e. flipped, later during fitting into the chip card, because the contact elements 16 facilitate a joint between the contact surfaces 8, situated on top, of the unrotated chip 7 and the contact connections of a conductor loop or antenna situated underneath.

According to a preferred embodiment of this invention, at the places at which parting of the contact elements 16 is to occur during the removal of the appropriate electrical unit 17 from the carrier tape 11 the contact elements 16 exhibit, for example, so-called predetermined breaking points (not shown) for fitting to a chip card body layer. These predetermined breaking points can be embodied as small perforations or constrictions. Furthermore, the contact elements 16 at the predetermined breaking points can, for example, be “notched” with a laser. An essential advantage of the application of predetermined breaking points is that on one hand the removal of the electrical unit 17, preferentially with stamping, is facilitated. On the other hand this avoids the contact elements 16 themselves from becoming damaged during parting, or that the electrical connection between the contact elements 16 and the connection surfaces 8 is damaged.

As shown schematically in FIGS. 3a to 3d, various embodiments of a carrier tape 11 are possible for the accommodation of electrical units 17, each exhibiting a chip 7 and contact elements 16, whereby the FIGS. 3a to 3d illustrate examples of four different possibilities.

FIG. 3a shows a carrier tape 11 in which the recesses 14 are embodied as penetrations. Furthermore, the surface of the carrier tape 11 is metallized, so that in this case the chips 7 are attached by the contact elements 16, whereby the contact elements 16 are joined at the points 18 to the carrier tape 11 by soldering, bonding or adhesion.

FIG. 3b shows a carrier tape 11 which has already been described in the explanations for FIG. 2. In this case the chips 7 can also be attached to the carrier tape 11 in order to stabilize the joint of the chips 7 to the adhesive tape 15.

FIG. 3c shows a carrier tape 11 with which the recesses 14 are not embodied as penetrations and therefore a support surface 19 is available for the chips 7. The contact elements 16 can be joined to the carrier tape 11 by soldering, bonding or adhesion for providing further fixing for the chips 7. In particular, the support surface 19 can be a foil which is joined to the back of the carrier tape 11 for the case when a carrier tape 11 is used with which the recesses 14 are embodied as penetrations.

FIG. 3d shows a carrier tape 11 which has already been described in the explanations for FIG. 3a. For further fixing of the chips 7 the contact elements 16 can in turn be joined to the carrier tape 11 by soldering, bonding or adhesion. For the case where the surface of the carrier tape 11 is not metallized, the chips 7 are fixed to the carrier tape 11 by the contact elements 16 themselves which join the individual chips 7 to one another.

The methods of forming electrical units, indicated as examples, are determined by the various possible arrangements of the connection surfaces 8 on the chips 7. Also other arrangements, such as for example diagonally fitting of the contact elements 8 to a chip 7 are possible, the connection surfaces of which are formed analogous to FIG. 3a.

FIGS. 4 and 4a illustrate the individual process steps for the manufacture of a carrier tape 11 with a plurality of electrical units 17, each exhibiting a chip 7 with connection surfaces 8 and contact elements 16 according to a further particular embodiment of this invention.

FIG. 4 shows the underside of a carrier tape 11 whereby the recesses 14 are embodied by penetrations and a metallized plastic foil or metallic foil 20 is formed on the upper side of the carrier tape 11. According to FIG. 4b) the chips 7 are fitted to the recesses 14 such that the connection surfaces 8 touch the foil 20. Then the foil 20 and the connection surfaces 8 are joined together.

The foil can preferentially be parted along the parting lines 21 to form the contact elements 16.

In the embodiments described above the production of the electrical connection between the foil and the connection surfaces 8 of the corresponding chips 7 can occur in various ways. Possibilities here are pressure, temperature, ultrasound, adhesives, soldering or welding. Formation of individual contact elements 16 from a foil can occur in each case before, during or after the production of this electrical connection, preferentially using a laser.

A principal advantage of stringing electrical units 17 together on the carrier tape 11 is that the further processing of these units 17 takes place with good transport capability and easily mechanized handling.

1. Method for the manufacture of a carrier tape (11) with a plurality of electrical units (17) whereby the carrier tape (11) is provided for the manufacture of transponders and the method comprises the following steps:
provision of a plurality of prefabricated chips (7) with at least one connection surface (8);
provision of a carrier tape (11) for the accommodation of the chips (7);
feeding of the carrier tape (11) to a chip placement device;
placement of at least one chip (7) on the carrier tape (11);
characterized by
provision of a metallized plastic foil or metallic foil for the formation of at least one contact element (16);
feeding of the metallized plastic foil or metallic foil to the carrier tape (11);
joining of the metallized plastic foil or metallic foil with the at least one connection surface (8) of the at least one chip (7) for the production of an electrical unit (17) from chip (7) and contact element (16).

2. Method according to claim 1, characterized in that the metallized plastic foil or metallic foil to be fitted to the chips (7) is joined to the carrier tape (11).

3. Method according to claim 1 or 2, characterized in that the metallized plastic foil or metallic foil to be fitted to the chips (7) is structured in order to predefine the shape of the at least one contact element (16).

4. Method according to one of the claims 1 to 3, characterized in that the metallized plastic foil or metallic foil to be fitted to the chips (7) is of aluminum, gold or copper.

5. Method according to one of the claims 1 to 4, characterized in that the metallized plastic foil or metallic foil to be fitted to the chips (7) exhibits at least the width of the at least one connection surface (8).

6. Method according to one of the claims 1 to 5, characterized in that the joining of the foil with the individual chips (7) occurs on at least two connection surfaces (8) of each individual chip (7).

7. Method according to claim 6, characterized in that the joining of the foil with the individual chips (7) occurs on two connection surfaces (8) of each individual chip (7) and the two connection surfaces (8) are each arranged at the same distance to one side of the relevant chip (7).

8. Method according to claim 6, characterized in that the joining of the foil with the individual chips (7) occurs on two connection surfaces (8) of each individual chip (7) and the two connection surfaces (8) are each arranged at different distances to one side of the relevant chip (7), whereby the two connection surfaces (8) of the relevant chip (7) are diagonally offset.

9. Method according to claim 8, characterized in that the width of the connection surfaces (8) corresponds approximately to the width of the chips (7) and the two connection surfaces (8) of the relevant chip (7) are arranged on opposite sides of the relevant chip (7).

10. Method according to claim 6, characterized in that the joining of the contact elements (16) to the individual chips (7) occurs on four connection surfaces (8) of each individual chip (7), whereby the connection surfaces (8) in each case are located in the corners of the relevant chip (7).

11. Method according to one of the claims 7 to 10, characterized by the following steps:
connection of the metallized plastic foil or metallic foil with one side of the carrier tape (11);
unrolling of the foil (16) in each case according to an intended length between the carrier tape and the first connection surface (8);
joining of the foil (16) with the first connection surface (8); cutting of the foil (16).

12. Method according to claim 11, characterized in that the metallized plastic foil or metallic foil is a wire.

13. Method according to claim 11 or 12, characterized in that the joining of the chips (7) to the metallized plastic foil or metallic foil is carried out by a soldering, bonding or adhesive process.

14. Method according to one of the claims 11 to 13, characterized in that the cutting of the metallized plastic foil or metallic foil occurs using a laser.

15. Method according to one of the claims 1 to 14, characterized in that the carrier tape (11) is earthed to avoid electro-static discharges.

16. Carrier tape (11) with a plurality of chips (7) for use in the mechanized manufacture of transponders, whereby the carrier tape (11) exhibits:
a plurality of approximately equally spaced penetrations (14) each for the accommodation of one chip (7);
a double-sided adhesive tape (15), for fixing the chips (7) in the penetrations (14), which is fitted on the underside and along the carrier tape (11) and overspans the penetrations (14); and
a plurality of chips (7) with at least one connection surface (8) each of which engages in the penetrations (14) and is fixed by the adhesive tape (15), whereby
the at least one connection surface (8) of the chip (7) is in each case joined, electrically conducting, with a contact element (16).

17. Carrier tape (11) with a plurality of chips (7) for use in the mechanized manufacture of transponders, whereby the carrier tape (11) exhibits:
a metallic or metallized surface;
a plurality of approximately equally spaced penetrations (14) each for the accommodation of one chip (7); and
a plurality of chips (7) with at least one connection surface (8) each of which is inserted into penetrations (14), whereby
the at least one connection surface (8) of the chip (7) is in each case joined, electrically conducting, to a contact element (16) and
the contact element (16) is joined at its other end to the metallic or metallized surface of the carrier tape (11).

18. Carrier tape according to claim 16 or 17, characterized in that the contact elements (16) are positioned such that in each case they extend from the chip (7) to the edges of the carrier tape (11).
